(19) United States
(12) Patent Application Publication
(10) Pub. No.: US 2025/0101778 A1
(43) Pub. Date: Mar. 27, 2025

(54) METHOD FOR PRODUCING A MOTOR VEHICLE CLOSING DEVICE, AND MOTOR VEHICLE CLOSING DEVICE

(71) Applicant: KIEKERT AKTIENGESELLSCHAFT, Heiligenhaus (DE)

(72) Inventors: Armin HANDKE, Duisburg (DE); Matthias OCHTROP, Dorsten (DE); Carsten FUCHS, Essen (DE)

(73) Assignee: KIEKERT AKTIENGESELLSCHAFT, Heiligenhaus (DE)

(21) Appl. No.: 18/730,971

(22) PCT Filed: Jan. 13, 2023
(86) PCT No.: PCT/DE2023/100019

§ 371 Date: Jul. 22, 2024

(30) Foreign Application Priority Data
Feb. 4, 2022 (DE) 10 2022 102 658.2

(51) Int. Cl. E05B 85/26; B23K 26/00; E05B 85/24

(52) U.S. Cl. CPC E05B 85/26; B23K 26/00; E05B 85/243

(57) ABSTRACT

A method for producing a motor vehicle closing device and in particular to a motor vehicle lock. Said motor vehicle lock is equipped with at least one metallic base element and a closing element. The base element and/or the closing element is subsequently at least locally reinforced after its shaping process or is equipped with such a reinforcement from the outset. According to the invention, bearing components of the closing element are connected to the base element by means of laser welding.

The invention relates to a method for producing a motor vehicle closing device, in particular a motor vehicle lock, having at least one metallic base element and a closing element, according to which the base element and/or the closing element is subsequently at least locally reinforced after its shaping process or is reinforced from the outset.

The motor vehicle closing device mentioned above is generally a motor vehicle lock and in particular a motor vehicle door lock. This can in turn be designed as, for example, a motor vehicle tailgate lock, a motor vehicle side door lock, a motor vehicle hood lock, a motor vehicle fuel filler flap lock, etc. In principle, this also includes backrest locks in connection with a motor vehicle seat, a motor vehicle lock for a motor vehicle flap, etc. The term motor vehicle closing device is therefore to be interpreted broadly within the scope of the present invention.

Motor vehicle door locks in particular are exposed to considerable forces exerted in the event of an accident or crash situation. These must generally be absorbed by the vehicle closing device or the vehicle door lock in the example case and introduced into the vehicle body. This is the only way to prevent an associated vehicle door from being opened inadvertently in such a case. For this reason, safety-relevant components, such as the metallic base element and also at least one metallic closing element, are solid and often made of steel. This is because breaking loads that substantially correspond to a weight or mass of one or several tons must be managed at this point.

For this reason, in such a motor vehicle door lock or a motor vehicle closing device, the lock case or a lock plate as a base element as well as a rotary latch and at least one pawl as closing elements are typically made of solid steel. Furthermore, additional components are often used to improve force transmission.

In accordance with DE 10 2014 115 704 A1, a motor vehicle door lock is designed in such a way that the material thickness of the lock case varies over its base area as a function of the expected loads. This results in a not inconsiderable technological effort.

In a method for producing a motor vehicle door lock with at least one lock case, as described in DE 10 2014 011 973 A1, the lock case is partially hardened during and/or after the punching process. This can be done with the aid of an induction coil or by using a laser beam or electron beams. In addition, the hardening process is carried out under a protective gas atmosphere with, for example, nitrogen and/or a noble gas.

The generic DE 10 2019 132 507 A1 takes a similar approach. In this case, the base element and/or the closing element are subsequently at least locally reinforced after the shaping process. For this purpose, the respective element can be induction and/or laser and/or flame hardened. This can increase the overall tensile strength and/or Vickers hardness compared to the untempered state.

The prior art has proven itself in principle, but still offers room for improvement. For example, in the known teaching, the tensile strength and/or Vickers hardness can be increased in the region of a recess for mounting one or more closing elements. However, additional improvements are possible at this point.

The invention is therefore based on the technical object of further developing such a method for producing a motor vehicle closing device in such a way that crash safety is further improved and greater breaking loads can be absorbed compared to the prior art.

In order to achieve this technical object, a generic method for producing a motor vehicle closing device within the scope of the invention is characterized in that bearing components of the closing element are connected to the base element by means of laser welding.

In order to further increase the strength, the invention goes a step further compared to the prior art according to DE 10 2019 132 507 A1. In addition to the local reinforcement of the base element or closing element, the invention provides that bearing components of the respective closing elements or the individual closing element are connected to the base element by means of laser welding. In this way, not only can synergy effects be exploited, but at the same time a particularly homogeneous and strong connection is provided between the respective bearing component and the closing element as well as the base element.

In fact, the procedure at this point can be such that, for example, and first of all, the base element is hardened in the region of a recess for the bearing component in question by the laser beam to be used in the region of the recess. The respective bearing component for the respective closing element can then be inserted into the respective recess. The bearing component can be a bearing pin and/or a bearing bush. One or both bearing components are then connected to the base element by means of laser welding. In principle, one and the same laser source can be used which was previously used for the tempering or reinforcement of the recess of the base element in this region. This allows synergy effects to be achieved and the manufacturing process as a whole to be carried out particularly efficiently.

In this context, it is understood that both the laser treatment and the laser welding can be carried out in a protective gas atmosphere, as has already been described in principle in the prior art. In principle, however, such a protective gas atmosphere is also unnecessary. In any case, the laser used at this point ensures, on the one hand, that the recess of the base element is reinforced by a tempering process and, on the other hand, that the bearing component received in the recess is then perfectly joined to the base element by laser welding.

In order to further increase the overall strength at this point, the bearing components and/or the base element and/or the closing element are advantageously made of a tempering steel. Such a tempering steel is one such as that described in detail in the standard DIN EN 10083-1 2006-10-00 on the subject of “Steels for quenching and tempering-Part 1: General technical delivery conditions; German version EN 10083-1:2006, pages 1 to 27” and is already the subject of the generic teaching according to DE 10 2019 132 507 A1.

The joining process between the bearing component of the respective closing element and the base element by laser welding is advantageously carried out in such a way that the bearing components in question and the base element are joined together by a fillet weld. Such a fillet weld is essentially a V-shaped depression which, according to the invention, is filled with welding material during the joining process or the laser welding process. This welding material can be supplied externally or is provided by the base element or bearing component as such. In any case, the implementation of the fillet weld in this region provides a particularly strong connection between the bearing component in question and the base element.

The same applies if the bearing component in question and the base element are joined together by an I-seam. Such an I-seam is particularly recommended in the event that a bearing pin is to be received in a corresponding recess in the base element. A more or less large cylindrical gap is observed between the bearing pin and the recess in the base element, which is now closed according to the invention with the aid of the I-seam by laser welding and leads to the joint between the respective bearing component or bearing pin and the base element. In this case, the cylindrical gap in question is not only closed, but, as a result of the I-shaped seam of the welded joint in cross-section, it is also joined on the top and bottom sides by the respective I-web to the bearing component or bearing pin on the one hand and the base element on the other.

In order to realize the at least local reinforcement of the base element or closing element in detail, the respective element is induction and/or laser and/or flame hardened within the scope of the invention. Typically, induction hardening and laser hardening have proven to be particularly advantageous at this point. In addition, the procedure is usually such that the base element is locally reinforced at least on the inside in the region of a respective bearing point of the closing element in question. Such local reinforcement of the base element, at least on the inside, can be achieved particularly easily by laser hardening the base element in the region of the bearing point in question. Of course, the base element can also be reinforced on both sides in the region of the bearing point. However, this requires laser hardening from both sides.

If induction hardening is used at this point, separate treatment of both surfaces of the base element is not necessary. Rather, induction hardening results in a consistent increase in tensile strength and Vickers hardness across the material thickness.

It has proven to be useful if all the elements, i.e. the base element and the closing element or multiple closing elements, are each made of a steel with a tensile strength of at least 1000 N/mm² and in particular of 1300 N/mm² and more. This typically results in a Vickers hardness of at least 400 HV. In contrast, it is sufficient for the bearing components if they are equipped with a tensile strength of at least 900 N/mm² and a Vickers hardness of approximately 300 HV and more.

In any case, following the method according to the invention for producing a motor vehicle closing device, it is observed that the motor vehicle closing device in question is able to absorb even greater breaking loads than the prior art. This can essentially be attributed to the fact that the base element in question and also the closing element are at least locally reinforced. In addition, bearing components with increased tensile strength and Vickers hardness are used here compared to the prior art. Finally, the achievable breaking loads are positively affected by the fact that, according to the invention, the bearing components for the individual or multiple closing elements are connected to the base element by means of laser welding. This is because such a laser welding process in this context and in particular the fillet weld or I-weld observed at this point results in a particularly homogeneous joining process which is able to absorb extraordinarily high loads in this region. These are the main advantages.

In the following, the invention is explained in more detail with the aid of a drawing showing only one exemplary embodiment; in which:

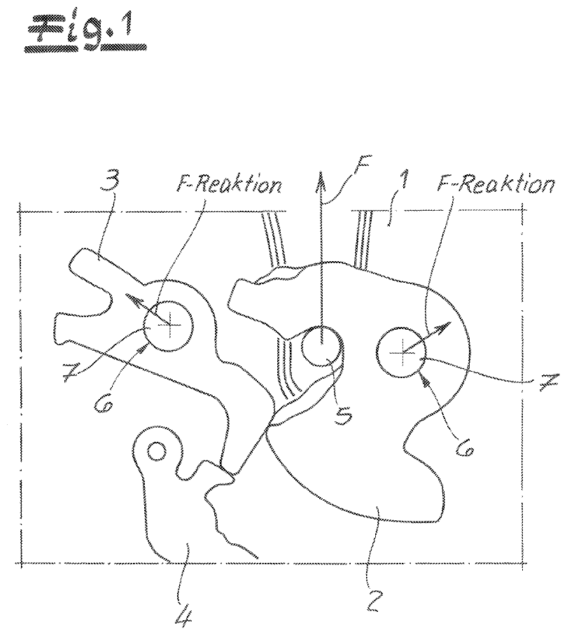

FIG. 1 shows a motor vehicle closing device according to the invention in the form of a motor vehicle lock with forces acting thereon in the event of a crash, and

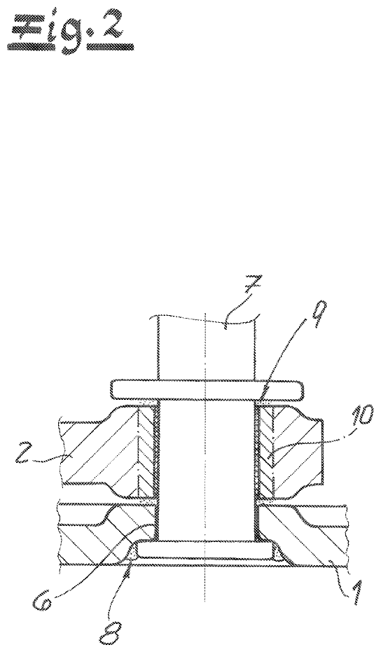

FIG. 2 shows the object according to FIG. 1 in parts and partly in section in the region of a bearing point for a closing element.

In the drawings, a motor vehicle closing device is shown. The motor vehicle closing device is, but is not limited to, a motor vehicle lock which is equipped with at least one metallic base element 1 and a metallic closing element 2, 3, 4. The base element 1 in the exemplary embodiment is a plate-shaped lock plate or a lock case 1. In contrast, the closing elements 2, 3, 4 are designed as a rotary latch 2 and two pawls 3, 4.

The two pawls 3, 4 are a comfort pawl 3 on the one hand and a blocking pawl 4 that secures the comfort pawl 3 on the other hand. Instead of the two-pawl locking mechanism shown in FIG. 1, a single locking mechanism or single-pawl locking mechanism with only a single pawl 3, 4 can of course also be used. However, this is not shown. In any case, FIG. 1 shows a force F acting on a lock holder 5, in particular in the event of a crash, which in response leads to reaction forces F-reaction acting on the associated hinge pin or bearing bolt or bearing pin 7 of the rotary latch 2 and of the comfort pawl 3, as outlined in FIG. 1. The force F may be due to a crash.

The reaction forces F-reaction lead to the lock plate 1 in the example case undergoing deformations indicated here in FIG. 2 in the region of a recess 6 of the lock plate 1 indicated in FIG. 2 for receiving the bearing bolt 7. In order to keep these deformations as small as possible and to be able to absorb high breaking loads or crash forces F with the aid of the motor vehicle closing device, various measures are provided within the scope of the invention.

Firstly, in one variant, the recess 6 is at least locally reinforced and has an increased tensile strength through, for example, laser hardening or induction hardening and also increased Vickers hardness in the region of the recess 6, as already described in the introduction. In addition, the base element 1 or the lock plate 1 in this case is made of a steel with a tensile strength of at least 1000 N/mm² and has a Vickers hardness of at least 400 HV. The same applies to the closing element 2 which is mounted here by way of example and with the aid of the bearing pin 7, which in the illustration according to FIG. 2 is the rotary latch 2.

From FIG. 2 it can be seen that the bearing pin 7 as a bearing component is inserted into the recess 6 in the base element or in the lock plate 1 or engages therein. In order to anchor the respective bearing component 7 or the bearing pin 7 in the lock plate 1, the solution according to the invention uses a special joining process, namely laser welding. In addition, the procedure here is such that the bearing component 7 in question and the base element 1 are joined together by a fillet weld 8 as can be seen in FIG. 2. The fillet weld 8 is V-shaped in cross-section and can be closed by welding material supplied from the outside or by welding material which is provided by a head of the bearing pin 7 inside the recess 6.

In addition, it is possible for the bearing pin 7 to be additionally received or anchored in a bearing bush 10, which is only indicated here. The bearing bush 10 can in turn be joined to the base element or the lock plate 1 again by a laser welding process. For this purpose, an I-seam 9 is used in the exemplary embodiment, which is also indicated in FIG. 2. In any case, the coupling of the respective bearing component 7 or 7, 10 of the respective closing element 2 by laser welding to the base element or the lock plate 1 as a whole ensures that particularly high breaking loads can be absorbed at this point. This is further enhanced by the fact that the material used for the bearing components 7, 10 is a steel with a tensile strength of at least 900 N/mm² and a Vickers hardness of approximately 300 HV and more. For the remaining elements 1, 2, 3, 4, the invention recommends using a steel with a tensile strength of at least 1000 N/mm² and a Vickers hardness of at least 400 HV.

### LIST OF REFERENCE SIGNS

Base element 1
Lock plate 1
Element 1, 2, 3, 4
Rotary latch 2
Comfort pawl 3
Closing element 2, 3, 4
Pawls 3, 4
Blocking pawl 4
Lock holder 5
Recess 6
Bearing component 7, 10
Bearing pin 7
Fillet weld 8
I-seam 9
Bearing bush 10
Crash force F
Force F

1. A method for producing a motor vehicle closing device the motor vehicle closing device having at least one metallic base element and a closing element, the method comprising:
the base element and/or the closing element being subsequently at least locally reinforced after a shaping process of the base element and/or the closing element, or is reinforced from the outset prior to the shaping process, and
laser welding bearing components of the closing element to the base element.

2. The method according to claim 1, wherein the bearing components and/or the base element and/or the closing element are made of a tempering steel.

3. The method according to claim 1, wherein the bearing components and the base element are joined together by a fillet weld.

4. The method according to claim 1, wherein the bearing components and the base element are joined together by an I-seam.

5. The method according to claim 1, wherein the bearing components comprise bearing pins and/or bearing bushes.

6. The method according to claim 1, wherein the base element and/or the closing element is induction and/or laser and/or flame hardened.

7. The method according to claim 1, wherein the base element is locally reinforced at least on an inside in a region of a respective bearing point of the closing elements.

8. The method according to claim 1, wherein the base element and the closing element are made of a steel with a tensile strength (Rm) of at least 1000 N/mm2, and have a Vickers hardness of at least 400 HV.

9. The method according to claim 1, wherein the bearing components are produced with a tensile strength (Rm) of at least 900 N/mm2 and a Vickers hardness of at least 300 HV.

10. A motor vehicle closing device, manufactured by a method according to claim 1, the motor vehicle closing device having at least one metallic base element and a closing element, wherein the base element and/or the closing element is subsequently at least locally reinforced after a shaping process of the base element and/or the closing element, or is reinforced from the outset prior to the shaping process, wherein
bearing components of the closing element are connected to the base element by laser welding.

11. The motor vehicle closing device according to claim 10, wherein the base element is a plate-shaped lock case and the closing element comprises a rotary latch and at least one pawl.

12. The motor vehicle closing device according to claim 10, wherein the bearing components comprise at least one bearing pin that is laser welded within a recess in the base element.

13. The motor vehicle closing device according to claim 12, wherein the at least one bearing pin additionally is anchored in a respective bearing bush that is laser welded to the base element.

14. The method according to claim 8, wherein the base element and the closing element have a tensile strength (Rm) of at least 1300 N/mm2.

15. The method according to claim 1, further comprising performing a laser treatment to harden the base element in a region of a recess for at least one of the bearing components.

16. The method according to claim 15, wherein the laser welding and the laser treatment are performed by a same laser source.
